(19) United States
(12) Patent Application Publication
(10) Pub. No.: US 2007/0269350 A1
(43) Pub. Date: Nov. 22, 2007

(54) Gas Sampling Bag

(76) Inventors: Linda S. Coyne, Pittsburgh, PA (US); Donald G. Pachuta, Bridgewater, NJ (US)

Correspondence Address: Beck & Thomas, P.C.;SUITE 100, 1575 McFARLAND ROAD, PITTSBURGH, PA, 15216-1808, US

(21) Appl. No.: 11/748,030

(22) Filed: May 14, 2007

Related U.S. Application Data
(60) Provisional application No. 60/747,380, filed on May 16, 2006.

(51) Int. Cl. B01L 3/00

(52) U.S. Cl. 422/102

(57) ABSTRACT

A gas sampling bag made of a flexible synthetic polymer has extremely low background contaminants in its interior and is treated to minimize further contaminant intrusions from its coupling components. Methods of making the bag are described; the invention includes a sampling bag, with treated inlet fittings, holding a gas sample having controlled low background contamination from volatile organic compounds.

### CROSS-REFERENCE TO RELATED APPLICATIONS

This application claims the benefit of U.S. Provisional Application No. 60/747,380 filed May 16, 2006 which is herein incorporated by reference.

### BACKGROUND OF THE INVENTION

1. Technical Field

A gas sampling bag made of a flexible synthetic polymer has extremely low background contaminants in its interior and is treated to minimize further contaminant intrusions from its coupling components. Methods of making the bag are described; the invention includes a sampling bag, with treated inlet fittings, holding a gas sample having controlled low background contamination from volatile organic compounds.

2. Description of Related Art

Gas sampling bags are used to take samples of gas from containers, various types of transmission lines, ambient air, indoor air, workplace air, and other sources, usually under pressure. In the beverage industry, for example, gas sampling bags are used to take samples from pressurized containers of carbon dioxide, in order to analyze for possible contaminants that could enter the beverages as they are carbonated.

The reader may be interested in studying the construction of sampling bags and similar containers described in the following U.S. Patents: Hamilton et al U.S. Pat. No. 6,468,477, Lafleur U.S. Pat. No. 6,139,482, Lenz et al U.S. Pat. No. 5,690,623, and Malin et al U.S. Pat. No. 6,468,732. Disclosures emphasizing the inlet fittings or other integral components of flexible containers include Frank U.S. Pat. No. 4,017,020, Kosuth U.S. Pat. No. 5,178,021, and Bond U.S. Pat. No. 4,601,410. Saranex® (trademark of Dow Chemical) is a flexible laminated sheet mentioned as a useful material for bag bodies in Hernandez U.S. Pat. No. 4,577,817, Riese U.S. Pat. No. 4,637,061, Vilutis U.S. Pat. No. 4,539,236 and Dollinger et al U.S. Pat. No. 5,164,268.

In recent years, the beverage industry in particular has embraced increasingly stringent tolerances for contaminants in carbon dioxide, and accordingly the accuracy of the analyses for the contaminants has been improved to aspire to determine concentration measurements in the single digit parts per million, well into parts per billion, and, in some cases, even to attempt parts per trillion. As a consequence of the increasing demand for more and more precise analyses and lower and lower tolerances for various materials that might be found in the gas, attention has been directed to the devices used to take the samples, the materials of their construction, and chemicals of various kinds that might be found in them.

Saranex®, mentioned above as a flexible laminated sheet, is said by its manufacturer, Dow Chemical Company, to be composed of solids and not liquids—that is, there are no solvent-based spray adhesives used to secure the laminations, and therefore its manufacture does not require extensive drying facilities and air emission controls for volatile organic compounds (VOCs).

Chemicals that might enter the gas sample from the sample bag itself, or from the fittings, tubing and other associated parts that help to collect the sample are sometimes called background contaminants. In some cases, where inadequate or no precautions are taken, the amount of background contaminant of a certain type in a sample could actually be greater than the amount indigenous to the sample itself, or, where the limit is set extremely low, greater than the entire amount said to be tolerable in the sample. Background contaminants can generally be viewed as being present in the sample from two significant possible sources—first, those that are already present in the sampling bag when the sample enters it, and, second, those that enter the sample from the fittings or the bag itself during transportation or storage of the sample.

There is a need in the industry to control and minimize sources of background contamination by volatile organic compounds.

### SUMMARY OF THE INVENTION

Our invention is a gas sampling bag having properties designed to minimize concentrations of various contaminants, both initially—that is, when the sample is first taken—and over time, while the sample resides in the bag awaiting processing for analysis of the sample it contains. An important aspect of the invention is the method of making it, which comprises (a) providing a bag body material having a VOC stability of 80% or greater for 2 or more days (b) forming an aperture in the bag body material (c) providing means to be fixed in the aperture for introducing a gas sample into the interior of the bag, (d) treating the means for introducing a gas sample into the interior of the bag to remove background contaminants therefrom, (e) fixing the means for introducing a gas sample into the interior of the bag in the sealed relationship with the aperture, and (f) forming a bag from the bag body material.

The fixture for introducing a gas sample may include a septum for extracting gas from the bag for analysis. A lubricant, substantially free of VOC's, is used around the edges of the aperture when the fixture is installed.

The sampling bag is substantially empty when it is provided to the user. By substantially empty, we mean that air and/or other gases are substantially absent from it at the time of manufacture and sealing. In particular, since our bag is made from two sheets of synthetic polymeric material, the bag is substantially flat, with the two sheets forming the two sides flattened against each other, as will be illustrated below. Only a very small amount of air is in the bag when it is ready for use, thus minimizing the possible entry into the interior of the bag of contaminants in the air indigenous to the manufacturing site.

Our invention includes (1) a method of making a sampling bag (2) a sampling bag made by the method, (3) a gas sampling bag characterized by excellent VOC (volatile organic compound) stability, and (4) a gas sample confined in a gas sampling bag and including very low background VOC (volatile organic compound) contamination and sulfur background.

### BRIEF DESCRIPTION OF THE DRAWINGS

FIG. 1 is an overhead view of our sampling bag.

FIG. 2 is an exploded view of the intake and septum assembly.

FIG. 3 is a perspective view of the bag after it is occupied by a gas sample.

FIG. 4 is an enlargement of the assembled fixtures.

In FIG. 5, the fixtures have been opened to permit a gas sample under pressure to enter the bag.

In FIG. 6, a syringe is shown piercing the septum to remove a portion of the sample contained in the bag, to be examined in an analytical instrument.

### DETAILED DESCRIPTION OF THE INVENTION

Valve in the claims means any device that can be used to let in and remove a sample from a bag.

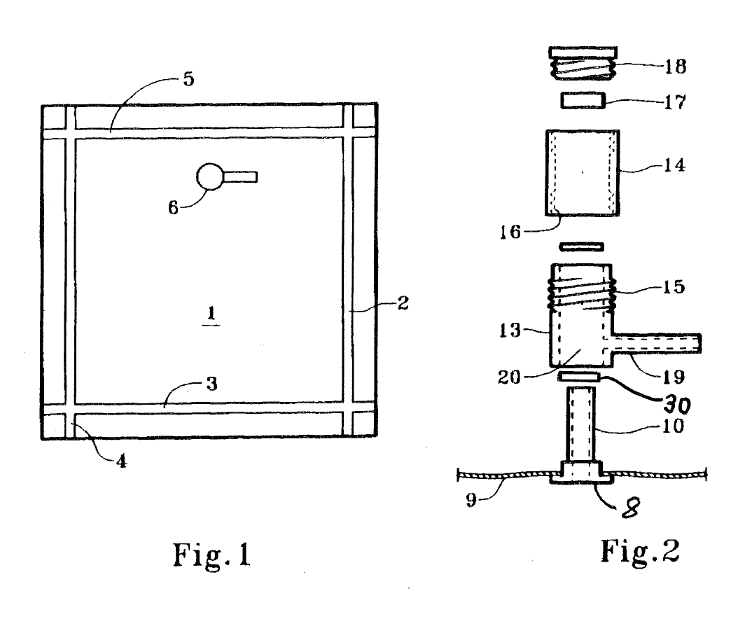

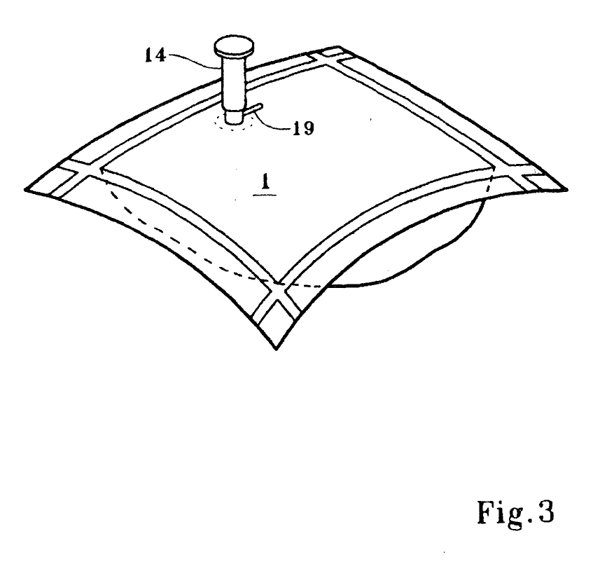

Referring now to FIG. 1, the sampling bag comprises a bag body 1 of synthetic polymer sheet material which is sealed at sealed edges 2, 3, 4, and 5. The synthetic polymer material is a laminated flexible sheet material whose manufacture does not include the use of solvent based spray adhesives. In this case, that is, in the paradigmatic illustration of FIG. 1, the synthetic polymer material is Saranex®. The bag body 1 comprises two sheets of the synthetic polymer material, and the sealed edges 2, 3, 4, and 5 are normally heat seals. Heat sealing may be accomplished in any convenient manner, but we prefer to use an Impulse Heat Sealer. The seals should be able to withstand a pressure test to be discussed below. The sampling bag also includes intake and septum assembly 6, which is explained further in FIG. 2.

It is not essential to heat seal all four edges of the sampling bag. For example, the synthetic polymer sheet material may be folded to form one edge, and the other three edges may then be heat sealed. If the sheet material is folded, care should be taken not to entrap more than a very small amount of air at the fold.

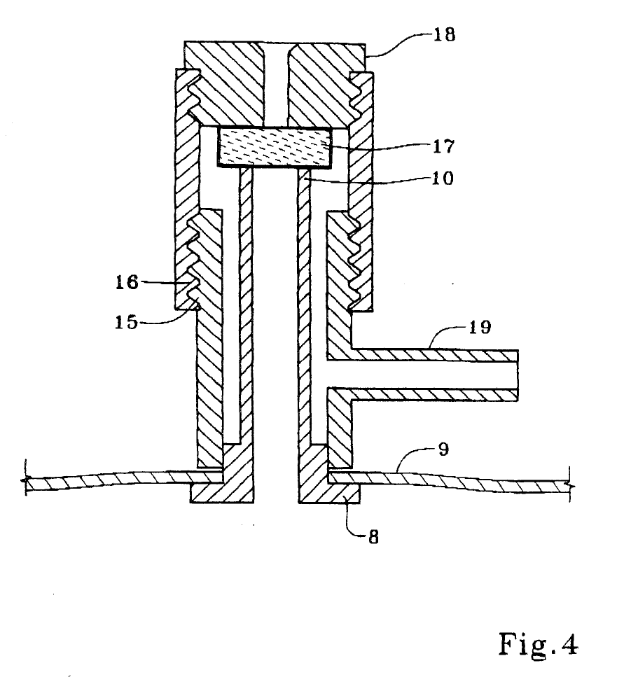

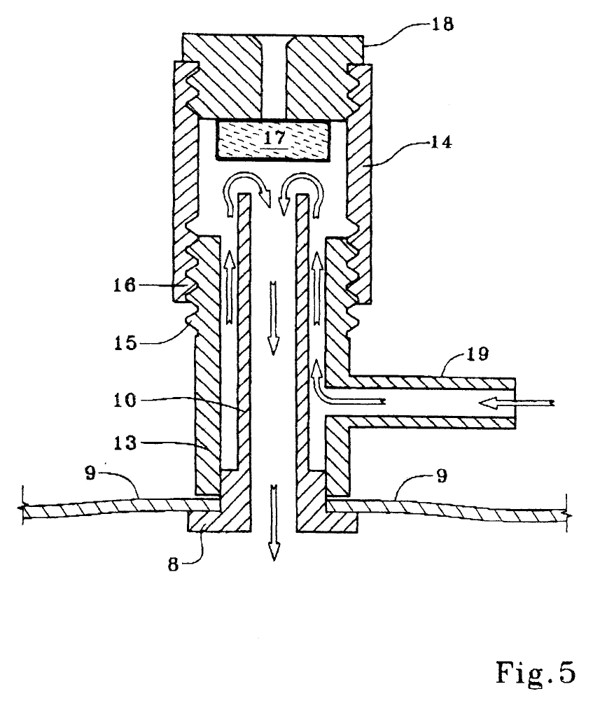

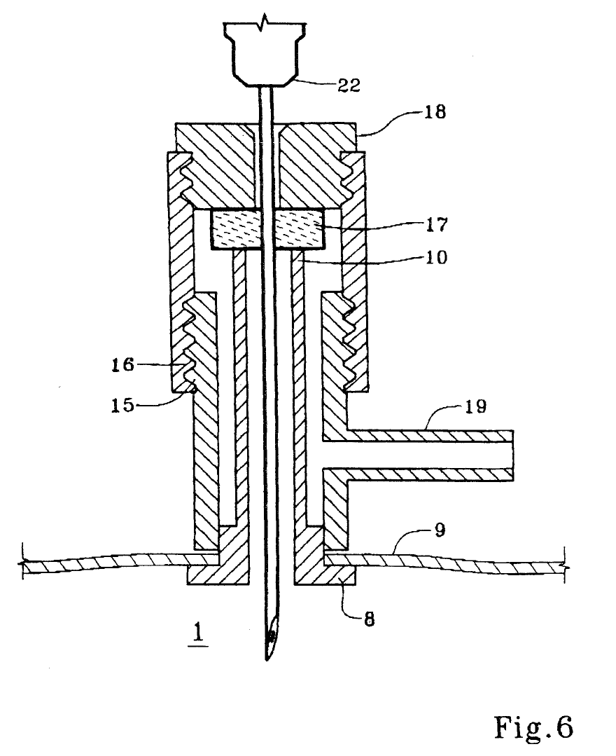

In FIG. 2, hollow stem 10 is inserted through a hole cut in a sheet 9 of the sampling bag, and is secured by a fastener 8 on the side of the sheet 9 intended to be inside the bag. An O-ring (synthetic elastomer material), 30, may reside on the side of the sheet intended to be outside the bag, and is used to seal the area around the hole in the sheet material and the hollow stem 10. Fastener 8 may be a nut which screws onto the threaded end of hollow stem 10, thus completing the airtight seal. A small amount of 1-decene homopolymer is used as a lubricant and sealant. Hollow stem 10 projects into the inside of inlet body 13, which is fastened to the hollow stem 10 by threads on both the inlet body 13 and the hollow stem 10. Inlet body 13 defines a substantially cylindrical space 20 into which the hollow stem 10 projects (see FIGS. 4, 5, and 6). Hollow stem 10 is not as large in outside diameter as substantially cylindrical space 20, and accordingly an empty channel will be formed between the concentric surfaces of hollow stem 10 and the inside of inlet body 13. Inlet body 13 has a tubular connector 19, of a size and shape to accommodate a complimentary connector from a source, not shown, of gas sample under pressure. Sleeve 14 encircles the upper portion of inlet body 13, again fastened to the inlet body by threads 15 on the outside of the inlet body 13 and threads 16 on the inside of sleeve 14. A septum 17, which is part of cap 18, is positioned to firmly rest on top of hollow stem 10. When assembly is completed, hollow stem 10 extends upwardly as far as the septum—that is, it firmly contacts the septum. 17. See FIG. 4. Thus a sample of gas entering the tubular connector 19 will have access to the cylindrical space 20 between the hollow stem 10 and the inlet body 13. However, it cannot enter the interior of hollow stem 10 unless the cap 18 is loosened to lift the septum 17 off the top rim of hollow stem 10, as is illustrated in FIG. 5.

Any device for securing the hollow stem to the bag side may be used instead of fastener 8; for example, a rivet or friction insert.

Saranex® laminated film is described by the manufacturer, Dow Chemical Company, as a layer of Saran® integrally coextruded between outer layers of polyolefins, having overall thicknesses ranging from 2 mils to 4 mils (0.002 to 0.004 inch). We are aware of at least fifteen varieties or grades of Saranex® laminated films, the differences being primarily in the type of polyolefins (frequently low density polyethylene), the thicknesses of the layers, and the number of plies or layers. Saranex® laminated films are widely used for various types of barrier and protective applications, including various medical applications. Considerable data are available as to their chemical resistance and barrier properties for many chemicals. Any of them are useful in our invention; more generally, we may use any flexible film comprising Saran® film coextruded or compressed between rolls with thin layers of polyolefin sheet. As is known in the art, Saran® is a film of polyvinylidene chloride frequently copolymerized with vinyl chloride, and we include materials of the generic description for use in our invention. That is, when we use the term polyvinylidene chloride, we mean to include all the commercially available variations of Saran® polymers of vinylidene chloride and its copolymers with vinyl chloride and/or other comonomers having high barrier capabilities for VOC's. A favored version of Saranex® laminated film in our invention is known as Saranex® 14 plastic film, which is a five layer coextruded barrier film 2 mil in thickness, with a structure of LDPE/EVA/PVDCE/EVA/LDPE—that is, a structure wherein a thin layer of ethylene vinyl acetate is inserted or coextruded between the Saran® film and the low density polyethylene film on each side. The high barrier coextruded or laminated multi-ply films useful in our invention may be laminated in a manner described by Vilutis in U.S. Pat. No. 3,329,549—that is, in addition to careful alignment of the films during lamination, using electrostatics to facilitate the clinging of one layer to another during manufacture, and/or partially evacuating the air available to the two layers of film at the point of contact during roll pressurization, in order to minimize the possibility of even minute quantities of air becoming enclosed between the layers.

Clear-Lay Rigid PVC Film

“Clear-Lay”™ is a polyvinyl chloride film available from Grafix Plastics of Cleveland, Ohio. Various filters or additives used to modify the physical appearance and/or surface properties may be present. Actual formula is proprietary. The films can be transparent to opaque. It is an odorless film that is chemically stable and resistant to water. The film used in our studies is manufactured by GRAFIX Plastics in Cleveland Ohio.

Teflon

Teflon® FEP is a fluorinated ethylene propylene resin/film. These films are manufactured by DuPont. They are known for their excellent chemical resistance which makes them extremely suitable for sampling bags. Teflon also provides outstanding temperature toughness and in general good durability. This film is a transparent, thermoplastic film that can be heat sealed, thermoformed, vacuum formed, heat bonded, welded, metalized, laminated-combined with dozens of other materials.

Because the bag bodies are chosen from material constructed without the use of adhesives that include organic solvents, they enable the manufacture of very stable, low-background containers for gas samples, without further treatment. Likewise, the lubricant we use to help seal the interfaces of the fittings and the bag body is chosen for its almost complete absence of volatile organic compounds—For this we use poly 1-decene. However, the fittings must be heat treated (baked) to remove volatile organic compounds (VOC's). To further keep the background of the bag low, low bleed septa, HT-X septa are used for this invention. However, the septa, fittings, and o-rings must be heat treated (baked) to remove some trace volatile organic compounds (VOCs).

We employ a vacuum degassed oven (that is, an oven under a negative pressure) to heat treat the hollow stem, inlet body, septum and related parts. Efficient times and temperatures are shown in the following list:

| | |
|---|---|
| septum | 250° C. (±25°) for 8 hours (±1.2 hours) |
| O-rings | 50° C. (±5°) for 24 hours (±2.4 hours) |
| Polypropylene fittings | 50° C. (±5°) for 8 hours (±1.2 hours) |
| Teflon cap | 50° C. (±5°) for 8 hours (±1.2 hours) |

In spite of the fact that the fittings, o-rings, septa, and Teflon cap are heated to drive off any residual VOCs, in spite of our use of 1-decene as the lubricant, and in spite of our use of Clear-Lay™ rigid PVC Film, Teflon™ FEP, and Saranex as the material of choice for the bag bodies, we may regularly perform a test to determine the effectiveness of our method of making bags and may find trace levels of VOCs. In this test, a finished sampling bag is filled with air of a given or tested purity and analyzed for a contaminant suspected of entering the sample from the sampler itself. Concentration of the contaminant in the air prior to entering the sampler is compared to concentration after it enters the bag. Similar comparisons can be made using carbon dioxide analyzed before and after placement in the sampling bag. Following are the results of such tests:

Our sampling bags are also subjected to stability tests. In this test, the finished sampling bag is filled with air; then a volatile organic compound, (frequently two of them), is injected into the bag and the gas in the bag is analyzed more than once over a period of hours, for example 48 hours or up to 10 days, but usually not longer than 3 days as recommended by the EPA guidelines. The gas is not under significant pressure—only enough, usually about one atmosphere, to assure that the bag will hold a sample approximately of the bag's capacity, such as one liter. A desirable target stability is at least 80% after two days. Following are results of such VOC stability tests using bags made of “Clear-Lay” vinyl and Saranex® 14.

TABLE 1
Percent Recoveries - “Clear-Lay” Vinyl

| Chemical | Day 1 | Day 2 | Day 3 | Day 4 | Day 5 | Day 6 | Day 7 |
|---|---|---|---|---|---|---|---|
| 1,2-Dichloroethane | 91.5 | 82.9 | NT | 80 | | | |
| Methyl ethyl ketone | 96.2 | 95.8 | NT | 80.6 | 79.5 | | |
| Heptane | 96.7 | 106 | NT | 89 | 89.2 | NT | 78.6 |
| Isopropyl alcohol | 99.1 | 91.7 | NT | 100 | 98.9 | 94.8 | |
| Benzene | 96 | 95.2 | NT | 85.5 | | | |
| Toluene | 107 | 92.9 | NT | 81.7 | 71.5 | | |
| Ethyl acetate | 94.9 | 95.4 | NT | 82.8 | 82.6 | 88.8 | 75.1 |
| Trichloroethylene | 92.4 | 82.9 | NT | 78.8 | 77.7 | | |
| Acetone | 96.7 | 88.9 | NT | 88.5 | | | |
| Methylene chloride | 93.2 | 87.2 | NT | 77.8 | | | |
| Propylene oxide | 93.3 | 90.1 | NT | NT | 79.9 | | |
| Allyl chloride | 95.6 | 91.9 | NT | NT | 83.1 | | |
| Acrylonitrile | 76.1 | 62.2 | NT | NT | 45.8 | | |
| Vinylidine chloride | 95.6 | 91.8 | NT | NT | 85.1 | | |
| Bromoethane | 95.2 | 90.9 | NT | NT | 82.7 | | |
| Acetonitrile | 69 | 55.1 | NT | NT | 36.7 | | |
| Methanol | 75.2 | 145 | 96.97 | NT | NT | 108 | |
| 2,2,4-trimethylpentane | 100 | 97.9 | 97.9 | NT | NT | 99.6 | |
| Dichloropropane | 86.2 | 76.7 | 71.8 | NT | NT | 48.6 | |
| Perchloroethylene | 94.8 | 84.9 | 80.6 | NT | NT | 81.6 | |
| Tetrahydrofuran | 96.7 | 93.6 | 93.4 | NT | NT | 93.1 | |
| 1,1,1-trichloroethane | 94.9 | 93.6 | 92.5 | NT | NT | 96 | |
| Butyl acetate | 85.1 | 91.8 | 74.1 | NT | NT | 69.3 | |
| p-Xylene | 85.9 | 82.7 | 78.1 | NT | NT | 69.6 | |
| Octane | 104 | NT | 98.7 | NT | NT | | |
| Chloroform | 98.7 | NT | 95.9 | NT | NT | | |

NT = not tested

TABLE 2
Percent Recoveries - Saranex ®

| Chemical | Day 1 | Day 2 | Day 3 | Day 4 |
|---|---|---|---|---|
| Heptane | 104 | 87.9 | 86.8 | NT |
| Ethyl acetate | 103 | 86.8 | 86.6 | NT |
| Trichloroethylene | 101 | 102 | 89.3 | NT |
| Methyl ethyl | 99.8 | 95.7 | 91 | 89.4 |
| ketone | | | | |
| Methylene | 95.8 | 94.8 | 91.5 | 86.95 |
| chloride | | | | |
| Toluene | 101 | 101 | 79.4 | 75.2 |
| Isopropyl alcohol | NT | 98.5 | 90 | 92.4 |

NT = Not tested

Our invention is not limited to a particular size bag or one of a particular capacity. The sampling bag may vary in capacity from 0.5 to 200 liters. Our sampling bag material has a VOC stability after two days of at least 80% for heptane, ethyl acetate, trichloroethylene, methyl ethyl ketone, methylene chloride, toluene, and isopropyl alcohol. Such a material may be called a barrier film.

FIG. 3 shows the bag 1 in a normally filled condition; this is a 1-liter bag containing a gas sample of about one liter of gas at approximately atmospheric pressure. Since the bag is filled, tubular connector 19 has been disconnected from the gas sample source, and sleeve 14 has been turned to seal the fixtures and retain the sample in the bag as shown in FIG. 4.

FIG. 4 shows the details of the configuration of the fixtures in FIG. 3. Threads 16 of sleeve 14 are completely engaged with threads 15 of inlet body 13, which compresses septum 17 firmly onto the top of hollow stem 10, thus preventing gas from moving upwards from bag 1 through hollow stem 10.

In FIG. 5, sleeve 14 has been elevated on threads 15 and 16, thus opening a space between septum 17 and the upper end of hollow stem 10, which permits the gas to be studied from the pressurized source not shown to proceed through tubular connector 19. The gas follows the path shown by the arrows through space 20 to the interior of the bag 1. Note that, instead of unscresing sleeve 14, septum 17 can be raised by lifting cap 18 on threads 23, since the septum 17 is built into cap 18.

FIG. 6 is similar to FIG. 4 except that a syringe 22 is shown piercing the septum 17. Such a syringe 22 is used to remove a portion of the gas sample occupying the interior of the sampling bag in order to analyze it, either for the purpose of testing stability of the background and contaminant content, or to determine the concentration of a particular contaminant of interest.

For testing, where a source of pure air, or air having minor known quantities of known constituents is used to fill the sampling bag, the background VOC's may be determined by difference. Our bag will have no more than two parts of background VOC (total of all types) per million parts of air. The background components come from (a) the very small amount of air present, already containing the VOC's, in the flattened empty bag such as is illustrated in FIG. 1, (b) the fittings, including lubricant, volatilized from them while the sampler bag is being filled or during the period in which the sample is held, and (c) the bag body material, entering the gas during the period in which the sample is held.

To use the device as shown in FIG. 1, the user first removes a simple cap (not shown), typically threaded, from the outside end of the tubular connector 19. Connector 19 is then connected to the gas source, such as a CO₂ cylinder, and the sample is passed through it to the sample bag by twisting sleeve 14, thus opening the passage for the gas from connector 19 through sleeve 14 and down hollow stem 10 to the bag's interior, as shown in FIG. 5. The bag will assume the pillow shape of FIG. 3, and the flow of gas may then be cut off by securing cap 18 and terminating the flow from the gas source; tubular connector 19 may again be closed off by a second cap, not shown. Having isolated a portion of the gas to be tested, a syringe 25 may be inserted through septum 17 to take an analytical sample from the bag.

Various changes could be made in the above construction and method without departing from the scope of the invention as defined in the claims below. It is intended that all matter contained in the above description as shown in the accompanying drawings shall be interpreted as illustrative and not as a limitation.

1. A method of making a gas sampling bag comprising:
(a) providing a flexible bag body material, the flexible bag body material having VOC stability data of at least 80% for greater than or equal to 2 days;
(b) forming an aperture in the bag body material;
(c) providing a valve for introducing a gas sample into the interior of the bag, the valve to be fixed in the aperture;
(d) fixing the valve in a sealed relationship with the aperture; and
(e) forming a bag from the bag body material so that when the bag contains a gas sample the bag has a VOC background of less than 2 ppm.

2. Method of claim 1 wherein the bag has a total sulfur background of less than 0.01 ppm and sulfur dioxide of less than 0.02 ppm.

3. Method of claim 1 wherein the flexible bag body material is Clear Lay Vinyl.

4. Method of claim 1 wherein the flexible bag body material is Saranex.

5. Method of claim 1 wherein flexible bag body material is Teflon.

6. Method of claim 1 wherein the valve is comprised of a tubular connector with an o-ring made of a synthetic elastomer material.

7. Method of claim 6 where the tubular connector and o-ring is vacuum degassed.

8. Method of claim 6 where the tubular connector is vacuum degassed at between 45-55 degrees Celsius for at least 8 hours.

9. Method of claim 6 wherein the o-ring is vacuum degassed at between 45-55 degrees Celsius for at least 24 hours.

10. Method of claim 1 wherein a septum is also provided for removing a sample of gas from the bag.

11. Method of claim 10 wherein the septum is vacuum degassed

12. Method of claim 11 wherein the vacuum degassing of the septum is conducted between at 225 degrees Celsius and 275 degrees Celsius for between for at least 8 hours.

13. Method of claim 1 wherein forming an aperture includes depositing 1-decene homopolymer as a lubricant around the edge of the aperture or the valve.

14. Method of claim 1 wherein VOCs comprise aromatic hydrocarbons, aliphatic hydrocarbons, chlorinated hydrocarbons, esters, ethers, alcohols, acetates, and aldehydes.

15. Method of claim 1 wherein total volatile oxygenates of the bag is less than 0.25 ppm.

16. Method of claim 1 wherein total methane in the bag is less than 0.25 ppm.

17. A sampling bag made by the method of claim 1.

18. A sampling bad made by the method of claim 2.

19. A device for taking samples of gas comprising:
(a) a bag having a VOC background of less than 2 ppm when the bag is filled with a gas sample, the bag formed from a flexible bag body material, the flexible bag body material having VOC stability data of at least 80% for greater than or equal to 2 days;
(b) an aperture in the bag, the aperture is the only opening in the bag, the rest of the bag being sealed; and
(c) a valve for introducing a gas sample into an interior of the bag, the valve fixed and sealed in the aperture.

20. The device as recited in claim 19 having a total sulfur background of less than 0.01 ppm and sulfur dioxide of less than 0.02 ppm.

21. The device as recited in claim 19 wherein the flexible bag body material is Clear Lay Vinyl

22. The device as recited in claim 19 wherein the flexible bag body material is Saranex

23. The device as recited in claim 19 wherein flexible bag body material is Teflon

24. The device as recited in claim 19 wherein the valve is comprised of a tubular connector with an o-ring made of synthetic elastomer material.

25. The device as recited in claim 24 wherein the tubular connector and o-ring are vacuum degassed

26. The device as recited in claim 24 wherein the tubular connector has been vacuum degassed at between 45-55 degrees Celsius for at least 8 hours.

27. The device as recited in claim 24 wherein the o-ring has been vacuum degassed at between 45-55 degrees Celsius for at least 24 hours.

28. The device as recited in claim 19 including a septum for removing a sample of gas from the bag.

29. The device as recited in 28 wherein the septum has been vacuum degassed.

30. The device as recited in claim 29 including 1-decene homopolymer as a lubricant around the edge of the aperture or the valve.

31. The device as recited in claim 19 wherein the VOCs comprise aromatic hydrocarbons, aliphatic hydrocarbons, chlorinated hydrocarbons, esters, ethers, alcohols, acetates, and aldehydes.

32. The device as recited in claim 19 wherein total volatile oxygenates of the bag is less than 0.25 ppm.

33. The device as recited in claim 19 wherein the bag has a total methane content less than 0.25 ppm.

34. A method for creating a gas sampling bag comprising:
(a) providing a bag body material having a VOC stability of 80% or greater for 2 or more days;
(b) forming an aperture in the bag body material;
(c) providing valve to be fixed in the aperture for introducing a gas sample into the interior of the bag;
(d) treating the valve to remove background contaminants from the valve;
(e) fixing the valve to the bag through the aperture;
(f) forming a bag from the bag body material.
The method as recited in claim 35 wherein treating the valve includes degassing the valve.
